(19) United States
(12) Patent Application Publication
(10) Pub. No.: US 2014/0195414 A1
(43) Pub. Date: Jul. 10, 2014

(54) METHOD FOR ESTABLISHING TERMS OF A FINANCIAL TRANSACTION USING PLAYER TRACKING DATA

(71) Applicants: BRYAN E. BULLARD, Las Vegas, NV (US); George J. Vasilakos, Las Vegas, NV (US); George S. Vasilakos, Las Vegas, NV (US); Benjamin L. Bartels, Las Vegas, NV (US); Navin Rongratana, Las Vegas, NV (US); John C. Huang, Las Vegas, NV (US)

(72) Inventors: BRYAN E. BULLARD, Las Vegas, NV (US); George J. Vasilakos, Las Vegas, NV (US); George S. Vasilakos, Las Vegas, NV (US); Benjamin L. Bartels, Las Vegas, NV (US); Navin Rongratana, Las Vegas, NV (US); John C. Huang, Las Vegas, NV (US)

(21) Appl. No.: 13/736,441

(22) Filed: Jan. 8, 2013

(51) Int. Cl. G06Q 40/02

(52) U.S. Cl. CPC G06Q 40/025
USPC 705/38

(57) ABSTRACT

A method for establishing one or more terms of a financial transaction comprises: receiving a player identifier; retrieving player tracking data provided by a player tracking system; and determining the at least one term based on the player tracking data. In one embodiment, the financial transaction is cashing of a check and the at least one term is a check cashing limit. The player tracking data may comprise of a player rating established by the tracking system or at least one type of player tracking data such as the player's previous bets and/or winnings. Player tracking data may be retrieved by a real-time electronic connection to the tracking system; by periodic exportation from the tracking system and importation into a check cashing system; or by separate retrieval from the tracking system and then manual imputation into the check cashing system for embodiments without an electronic interface to the tracking system.

### FIELD OF THE INVENTION

The present invention relates to determining the terms of a financial transaction. More particularly, the present invention relates to a method and system for establishing one or more terms of a financial transaction using data provided by a gaming establishment's player tracking system.

### BACKGROUND

Financial transactions generally involve a money, payment, and/or credit transaction such as buying or selling of goods, borrowing money from a lender, utilizing a cash advance from a credit card or debit card, withdrawing money from an automated teller machine, depositing funds into a bank account, and cashing a check. Whether the financial transaction involves a sale, purchase, loan, mortgage, credit card, debit card or bank account transaction, the terms of financial transactions are usually determined by data collected by credit bureaus or consumer reporting agencies. Examples of financial transaction terms that are typically determined by data collected by credit bureaus include: interest rates, loan principal amounts, credit line limits, minimum down payment requirements, repayment terms, monthly payment amounts, check cashing limits, guarantee fees, and various transaction fees.

Credit bureaus collect and compile information into credit reports and generate credit scores (e.g., FICO® scores) that are typically used by creditors, lenders, and other entities to assess credit worthiness of a consumer and to determine the terms of a financial transaction. A credit score is calculated from data that is derived from the consumer's payment history, amounts owed, length of credit history, new credit activity, and types of credit used (e.g., credit card accounts, retail accounts, installment loans, mortgages). Credit bureaus usually collect information from data furnishers with whom the bureaus have a relationship such as creditors, lenders, debt collection agencies, utility entities, and federal and local government agencies that provide court records, state recorder's office records, tax records, and other public records.

However, the use of data collected by credit bureaus to determine the terms of a financial transaction has a number of limitations and disadvantages. For instance, credit reports produced by different credit bureaus may contain varying or conflicting information on an individual consumer due to inconsistent reporting by the creditors, inconsistent data processing by the credit bureaus, and/or the inclusion of erroneous data. Some creditors may report only to one selected credit bureau as opposed to all major credit bureaus. Thus, there is a likelihood that a credit report produced by one credit bureau does not contain the consumer's complete and accurate credit history, which may be problematic for creditors and lenders who retrieve credit reports from only one credit bureau. Additionally, credit reports are susceptible to error, which may arise from inaccurate data collection, data entry, data reporting, and/or data processing by creditors and/or by credit bureaus. It is not uncommon for consumers to find errors in their credit reports, and such errors may serve as a basis for the denial of credit or for undesired financial transaction terms such as a high interest rate, large down payment requirement, low credit line limit, low check cashing limit, high guarantee fees, or high transaction fees.

Even if a credit report is accurate, the information contained in a credit report may not be truly indicative of a consumer's propensity to comply with the terms of a particular financial transaction agreement. Credit reports often contain information that is not relevant to a particular financial transaction being executed, and they may contain information that is not truly reflective of a consumer's overall credit history and credit worthiness. For example, a credit report may include fraudulent transactions made via identity fraud, and although such transactions were not authorized by the consumer, they may nonetheless adversely affect the consumer's ability to obtain favorable terms for a financial transaction until the fraud issues are fully resolved and the credit report is repaired, which may take several months or even years. Also, one bad entry on a credit report can adversely affect a consumer's credit score and ability to obtain credit. For instance, a collections account for a small dollar amount may disproportionally harm a consumer's credit score despite the perfect payment history and good standing of the consumer's other accounts.

Moreover, credit reports and credit scores generated by the credit bureaus are not an accurate measure of a consumer's present-day propensity and ability to fulfill the terms of a financial transaction since the information contained in credit reports is not entirely current. Creditors usually do not report updated consumer information to the credit bureaus until after the end of each billing cycle or predetermined period of time, which may be on a monthly, bi-monthly, quarterly, or other basis. Also, some creditors may not be diligent with periodic reporting of updated consumer information to the credit bureaus. As a result, credit bureaus do not possess complete and current data relating to a consumer's payment and credit activity that occurs between reporting periods. For example, if a consumer paid off all of his debts in full, which would improve his overall credit score, such payment activity would not be included in the consumer's credit report until after the end of the current billing cycle. Consequently, it may take months before the consumer's credit score is increased as a result of paying off all debts. On the other hand, if a consumer regularly pays off his credit card balances in full after the beginning of each billing cycle (and after creditors report to the credit bureaus), and the consumer then regularly incurs charges reaching his maximum credit limits at the end of each billing cycle (and immediately before creditors report to the credit bureaus), then the creditors will report high balances or a high debt-to-credit ratio to the credit bureaus which would reduce the consumer's overall credit score. Nevertheless, the delay in creditor reporting to the credit bureaus and the credit bureaus' failure to maintain real-time up-to-date consumer data may depict an inaccurate and incomplete picture of the consumer's credit and payment history and may prevent a consumer from presently obtaining credit or favorable terms for a financial transaction.

Additionally, credit reports may contain data derived from public records and judgments that are several years old, and such data is not necessarily relevant to the financial transaction to be executed by the consumer. Foreclosures, bankruptcies, court judgments, and tax liens can remain on a credit report for several years and ultimately affect a consumer's credit score. Although such items have long-lasting consequences on a consumer's credit report, other relevant factors such as a collapsed real estate market, an economy in recession, loss of a job, or illness are not considered to mitigate damage to a credit score. Furthermore, data derived from public records and judgments may disproportionally impair a consumer's present-day ability to execute even minor financial transactions (e.g., obtaining a small line of credit or a modest check cashing limit) despite the consumer's current improved status, which may be evident by the consumer's increased income, increased purchase or spending activity, and other factors that are not tracked by credit bureaus. Therefore, to better determine the terms of a particular financial transaction, a creditor or lender may desire to consider other types of data and factors that are not calculated into a credit score provided by a credit bureau.

Accordingly, there is a need in the art for a method and system that utilizes consistent, accurate, complete, relevant, and current data for determining one or more terms of a financial transaction. There is a need in the art for a method and system that considers data that is relevant to a particular financial transaction being executed and indicative of the consumer's propensity to comply with the terms of a particular financial transaction agreement. There is therefore a need in the art for a method and system that considers other types of data and factors that are not considered by credit bureaus. Furthermore, there is a need in the art for a method and system that considers real-time up-to-date data to assess a consumer's present-day propensity and ability to fulfill the terms of a financial transaction agreement. A method and system that addresses all of the above-mentioned drawbacks in the art would not only provide a more accurate determination of a consumer's current propensity and ability to comply with the terms of a particular financial transaction agreement, but it would also enable the occurrence of more financial transactions, increase the credit available to consumers who would have been denied credit based on credit bureau data, improve financial transaction terms for consumers who would have obtained unfavorable terms based on credit bureau data, and be more profitable to creditors and lenders through reduced risk of default by consumers and increased interest and transaction fee revenue. Other advantages of the present invention will be apparent to one of ordinary skill in the art in light of the ensuing description of the present invention.

### SUMMARY

The present invention is directed to a method and system that utilizes consistent, accurate, complete, relevant, and current data for determining one or more terms of a financial transaction. The data considered in the method and system of the present invention is relevant to a particular financial transaction being executed, indicative of the consumer's propensity to comply with the terms of a particular financial transaction agreement, and is comprised of types of data and factors that are not considered by credit bureaus and calculated into credit scores. Additionally, the method and system of the present invention considers real-time, up-to-date data to assess a consumer's present-day propensity and ability to fulfill the terms of a financial transaction agreement.

Instead of information collected by credit bureaus such as payment history, amounts owed, length of credit history, new credit activity, types of credit used, and public records that may reflect bankruptcies, foreclosures, tax liens, and court judgments, the present invention incorporates the consideration of player tracking data collected by a gaming establishment's player tracking system. The player tracking system tracks player gaming activity that occurs within a gaming establishment or within a group of affiliated or commonly owned gaming establishments. The player tracking system tracks gaming activity at slot machines, video gaming machines (e.g., video poker machines, video keno machines, etc.), table games, and at the race and sports book. The player tracking system collects data via player cards or reward cards that are inserted into the card reader of gaming machines or provided to the host at table games. Player tracking data may comprise of the player's coin-in activity (bets), coin-out activity (payouts), length of total game play, length of membership, type of games played, and various types of other player-related data. The player tracking data to be considered in determining one or more terms of a financial transaction may be comprised of a player rating determined by the player tracking system. The player rating may be described in several different manners such as a descriptive or tier value (e.g., Gold, Silver or Bronze) or described in a numeric form generally referring to the player's coin-in or coin-out over a period of time. Alternatively, the player tracking data to be considered in determining one or more terms of a financial transaction may be comprised of at least one type of player tracking data such as the player's coin-in and/or coin-out activity in a given time. In some embodiments of the present invention, the player tracking data may be retrieved through a real-time electronic connection to the player tracking system to provide the most current data on any given player. To achieve the foregoing and in accordance with the purposes of the present invention, the present invention is directed to a method for establishing one or more terms of a financial transaction comprising: (a) receiving a player identifier; (b) retrieving player tracking data wherein the player tracking data is provided by a player tracking system; and (c) determining the at least one term based on the player tracking data. The financial transaction may involve a sale, purchase, loan, mortgage, credit card, or bank account transaction such as buying or selling of goods, borrowing money from a lender, utilizing a cash advance from a credit card or debit card, withdrawing money from an automated teller machine, depositing funds into a bank account, or cashing a check. For example, the financial transaction may be a loan, and the term(s) to be determined by the player tracking data may comprise of one or more transaction fees, the interest rate, and/or the principal amount of the loan. In another example, the financial transaction may be a withdrawal of money from an automated teller machine, and the term(s) to be determined may comprise of transaction fees; bill denominations, quantities, and disbursement; and/or the maximum withdrawal amount. The financial transaction may also be a cash advance from a credit card, and the term(s) to be determined may comprise of transaction fees, interest rate, and/or minimum monthly payment amounts. In another variation of the invention, the financial transaction may be cashing of a check, and the terms to be determined may comprise a check cashing limit, a guarantee fee, and/or transaction fees.

In an additional embodiment of the present invention, a method for establishing a check cashing limit for a patron of a gaming establishment comprises: (a) receiving a patron identifier; (b) retrieving a player rating of the patron wherein the player rating is determined by a player tracking system; and (c) calculating the check cashing limit based on the player rating. In one embodiment of the invention, the check cashing limit is proportional to the player rating (i.e., the higher the player rating, the higher the check cashing limit). In some versions of the invention, the player rating may be a numerical value, and the check cashing limit is directly proportional to the player rating. In such versions, a check cashing limit may be designated for each player rating of a numerical value wherein the higher the player rating, the higher the check cashing limit. For embodiments of the invention that include an electronic connection or interface to the player tracking system, the player rating may be retrieved via a real-time electronic connection to the player tracking system such as through an Internet network connection or a LAN (local area network). Alternatively, the player rating may be periodically exported from the player tracking system and imported into a check cashing system. In such versions of the invention, the player rating may be stored in a database contained in the check cashing system. For embodiments of the invention that do not include an electronic interface to the player tracking system, the cashier may retrieve the player rating of the patron from the player tracking system and then input the player rating into the check cashing system such that the check cashing system receives the player rating. In such versions of the invention, the method further comprises the check cashing system receiving the player rating before the check cashing limit is determined. The method of the present invention may further include storing check cashing activity data of the patron into the check cashing system. In such embodiments, subsequent check cashing limits may also be based on a combination of the player rating and past check cashing activity data.

In a further embodiment of the present invention, a method for establishing a check cashing limit for a patron of a gaming establishment comprises: (a) receiving a patron identifier; (b) retrieving at least one type of player rating data of the patron wherein the at least one type of player rating data is provided by a player tracking system; and (c) determining the check cashing limit based on the at least one type of player rating data. The at least one type of player rating data may be comprised of the patron's past bets and/or the patron's past winnings. For versions of the invention that include an electronic connection or interface to the player tracking system, the player rating data may be retrieved via a real-time electronic connection to the player tracking system such as through an Internet network connection or a LAN (local area network); or the player rating data may be periodically transferred from the player tracking system to the check cashing system wherein the check cashing system includes a database that stores player rating data. For embodiments of the invention that do not include an electronic interface to the player tracking system, the cashier may retrieve the player rating data of the patron from the player tracking system and then input the player rating data into the check cashing system to calculate the check cashing limit. In such versions, the method of the present invention further includes the check cashing system receiving the player rating data to calculate the check cashing limit.

Another aspect of the present invention is directed to a check cashing system comprising: (a) a receiving mechanism that receives a player identifier; (b) a retrieving mechanism that retrieves player rating data wherein the player rating data is generated by a player tracking system; and (c) a calculating mechanism that calculates a check cashing limit based on the player rating data. The retrieving mechanism may be comprised of a real-time electronic connection between the check cashing system and the player tracking system. Alternatively, the receiving mechanism and the retrieving mechanism may be contained in the player tracking system, and the check cashing system further includes a second receiving mechanism that receives the player rating data after it is inputted into the check cashing system. In such versions of the invention, there is no electronic connection or interface between the check cashing system and the player tracking system as the player rating data is separately retrieved from the player tracking system and then inputted into the check cashing system. In another embodiment, the check cashing system may further include a database that stores the player rating data, and the retrieving mechanism updates the database by periodically transferring the player rating data from the player tracking system to the database.

The above description sets forth a summary of embodiments of the present invention so that the detailed description that follows may be better understood and contributions of the present invention to the art may be better appreciated. Some of the embodiments of the present invention may not include all of the features or characteristics listed in the above summary. There may be, of course, other features of the invention that will be described below and may form the subject matter of claims. In this respect, before explaining at least one embodiment of the invention in further detail, it is to be understood that the invention is not limited in its application to the details of the construction and to the arrangement of the components set forth in the following description or as illustrated in the drawings. The invention is capable of other embodiments and of being practiced and carried out in various ways. Furthermore, it is to be understood that the phraseology and terminology employed herein are for the purpose of description and should not be regarded as limiting.

Other features, aspects, and advantages of the present invention will become apparent from the following description of the invention, taken in conjunction with the accompanying drawings, which illustrate, by way of example, various features of embodiments of the invention.

### BRIEF DESCRIPTION OF THE DRAWINGS

FIG. 1 depicts a block diagram illustrating a method for establishing one or more terms of a financial transaction in accordance with an embodiment of the present invention.

FIG. 2 depicts a block diagram illustrating a method for establishing one or more terms of a financial transaction in accordance with an embodiment of the present invention.

FIG. 3 depicts a block diagram illustrating a method for establishing a check cashing limit in accordance with an embodiment of the present invention.

FIG. 4 depicts a block diagram illustrating a method for establishing a check cashing limit in accordance with an embodiment of the present invention.

FIG. 5 depicts a block diagram illustrating a method for establishing a check cashing limit in accordance with an embodiment of the present invention.

FIG. 6 depicts a block diagram illustrating a method for establishing a check cashing limit in accordance with an embodiment of the present invention.

FIG. 7 depicts a block diagram illustrating a check cashing system in accordance with an embodiment of the present invention.

### DESCRIPTION OF THE INVENTION

In the following description of embodiments of the invention, reference is made to the accompanying drawings, which form a part of this application. The drawings show, by way of illustration, certain embodiments in which the invention may be practiced. It is to be understood that other embodiments may be utilized and modifications may be made without departing from the scope of the present invention. Also, it is to be understood that the phraseology and terminology employed herein are for the purpose of description and should not be regarded as limiting.

The order in which the actions are presented below is not limited to any particular order and does not necessarily imply that they have to be performed in the order presented. It will be understood by those of ordinary skill in the art that the order of these actions can be rearranged and performed in any suitable manner. It further will be understood by those of ordinary skill in the art that some actions may be omitted, added, modified and/or consolidated and still fall within the spirit of the invention.

### Method for Establishing One or More Terms of a Financial Transaction

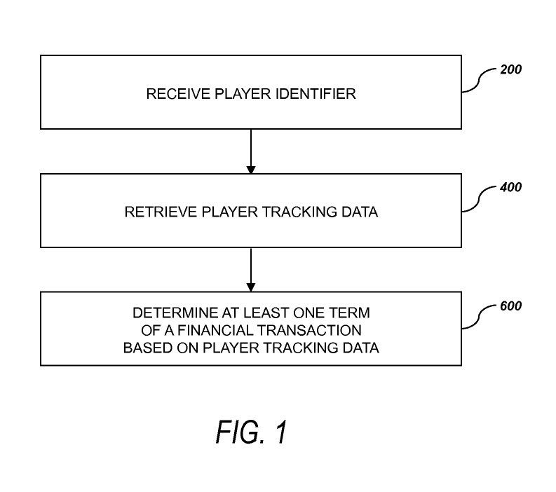

FIG. 1 depicts a block diagram illustrating a method for establishing at least one term of a financial transaction in accordance with an embodiment of the present invention. In general, a computerized system administering the financial transaction, either alone or in combination with a player tracking system, receives a player identifier (action 200); retrieves player tracking data (action 400); and determines at least one term of the financial transaction based on the player tracking data (action 600).

A computerized system of the present invention may perform all or some of actions 200, 400, and 600. For instance, in some embodiments of the invention, a computerized system of the present invention performs all of actions 200, 400, and 600.

Such embodiments may include an electronic interface to the player tracking system and/or may include a database that stores player tracking data. Still referring to FIG. 1, the computerized system receives the player identifier (action 200), which is inputted into the computerized system by a person handling the financial transaction or by the player for self-service financial transaction machines such as automated teller machines. The computerized system then retrieves player tracking data (action 400), which is stored in the computerized system and/or retrieved via an electronic connection to the player tracking system. The computerized system then determines at least one term of the financial transaction based on the player tracking data (action 600).

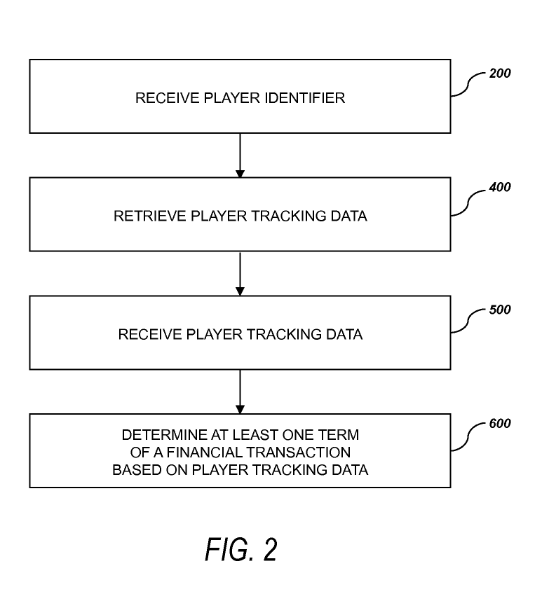

In additional embodiments of the invention, a computerized system of the present invention may work in conjunction with the player tracking system to perform actions 200, 400, and 600, as for example, in embodiments of the invention that do not include an electronic interface to the player tracking system. In such embodiments, a person retrieves the data from the player tracking system and then inputs said data into the computerized system of the present invention. FIG. 2 depicts a block diagram illustrating a method for establishing at least one term of a financial transaction in accordance with such embodiments of the present invention. The player tracking system receives a player identifier (action 200), which is inputted by the person handling the financial transaction. The player tracking system then retrieves player tracking data (action 400), and the person then inputs the player tracking data into the computerized system of the present invention so that the computerized system receives the player tracking data (action 500). The computerized system then determines at least one term of a financial transaction based on the player tracking data (action 600).

Yet, in a further embodiment of the invention, some of actions 200, 400, and 600 may be performed manually by a person. For instance, referring back to FIG. 1, the player tracking system receives a player identifier (action 200), which is inputted by the person handling the financial transaction, and the player tracking system then retrieves the player tracking data (action 400). The person may then manually determine at least one term of a financial transaction based on the player tracking data (action 600). For example, the person can perform action 600 by using a reference table, chart, or graph that designates various values for financial terms, by using one or more mathematical formulas to calculate values for at least one term of the financial transaction, or by using any other suitable reference.

The player identifier can be any form of government issued identification such as a driver's license or passport, a player card or reward card issued by the gaming establishment, an identifying number (e.g., social security number, driver's license number, player card number, or house account number), biometric data such as a fingerprint, or any other form of identification that can be used to retrieve the player's tracking data from either the player tracking system or computerized system of the present invention.

The financial transaction for which one or more terms are determined by the method of the present invention generally involves a money, payment, and/or credit transaction such as a sale, purchase, loan, mortgage, credit card, debit card or bank account transaction. Examples of financial transactions include: buying or selling of goods or property, borrowing money from a lender, financing a purchase, utilizing a cash advance from a credit card or debit card, withdrawing money from an automated teller machine, depositing funds into a bank account, and cashing a check. The terms that are determined by the method of the present invention may comprise of any term relevant to the financial transaction such as interest rates, loan principal amounts, credit line limits, minimum down payment requirements, repayment terms, monthly payment amounts, check cashing limits, guarantee fees, and various transaction fees.

For example, a patron of a casino establishment may want to purchase goods on credit from a retail store located within the casino property. Instead of retrieving the patron's credit report and/or credit score produced by the credit bureaus to determine the terms of the credit transaction, the salesperson would perform the method of the present invention. Referring to FIG. 2, the salesperson inputs a player identifier into the player tracking system so that the player tracking system receives the player identifier (action 200). The player tracking system then retrieves the player tracking data (action 400). The salesperson then inputs the player tracking data into the computerized system of the present invention so that the computerized system receives the player tracking data (action 500). At least one term of the financial transaction is then determined based on the player tracking data (action 600). For instance, the terms determined in action 600 may include the patron's maximum credit line, interest rate, and minimum monthly payments.

A variation of the foregoing method may be performed for embodiments of the invention that include an electronic connection to the player tracking system. Referring back to FIG. 1, the salesperson inputs the player identifier directly into the computerized system (as opposed to inputting the player identifier into the player tracking system), and the player identifier is thus received by the computerized system (action 200). The computerized system then retrieves the player tracking data via an electronic interface to the player tracking system or by retrieving data from a database contained in the computerized system (action 400). At least one term of the financial transaction is then determined based on the player tracking data (action 600).

In another example, a patron of a gaming establishment may want to withdraw money from an automated teller machine located within a gaming establishment. Still referring to FIG. 1, the automated teller machine receives a player identifier (action 200). The player identifier may be in the form of a bank-issued ATM card and/or a player card issued by the gaming establishment. The automated teller machine then retrieves the patron's player tracking data (action 400), which can be retrieved via an electronic connection to the player tracking system. At least one term of the financial transaction is then determined based on the player tracking data (action 600) before the cash is dispersed. The at least one term determined may comprise of transaction fees; bill denominations, quantities, and disbursement; and/or the maximum withdrawal amount.

Yet, in a further example, a patron of a gaming establishment may want to cash a check. Referring to FIG. 1, the person handling the check cashing transaction inputs the player identifier into the computerized system, and the player identifier is thereby received by the computerized system (action 200). The computerized system then retrieves the player tracking data via an electronic interface to the player tracking system or by retrieving data from a database contained in the computerized system (action 400). At least one term of the check cashing transaction is then determined based on the player tracking data (action 600). In various embodiments of the invention, the at least one term may be comprised of a guarantee fee, a check cashing limit, and/or transaction fees. For example, instead of a fixed-value guarantee fee (i.e., a fee that the cash access provider charges to guarantee payment on an approved check cashing transaction) for all checks at a specific location, one embodiment of the invention may vary the guarantee fee for each player based on player tracking data. For instance, in action 600, a guarantee fee may be determined based on player tracking data comprised of player ratings. In one version, the guarantee fee may be based generally on an inverse relationship with the player rating (i.e., generally, the higher the player rating, the lower the guarantee fee) wherein the guarantee fee is subject to predetermined minimum and maximum limits. In other versions of the invention, a lower guarantee fee may be determined if the player rating meets some pre-designated threshold.

Although the present invention considers player tracking data of a patron to determine or calculate one or more terms of a financial transaction, the financial transaction is not limited to financial transactions that occur within a gaming environment, nor does the financial transactions need to relate to gaming. The method of the present invention and the consideration of player tracking data may be used to determine one or more terms for a variety of financial transactions. For instance, the financial transaction may be a secured or unsecured loan, and the term(s) to be determined by the player tracking data may comprise of transaction fees, the interest rate, the minimum down payment required, and/or the principal amount of the loan. In another example, the financial transaction may be a withdrawal of money from an automated teller machine that is not located within a gaming establishment's property or that is not affiliated with a gaming establishment; and the term(s) to be determined may comprise of transaction fees; bill denominations, quantities, and disbursement; and/or the maximum withdrawal amount. The financial transaction may also be a cash advance from a credit card that is not affiliated with a gaming establishment, and the term(s) to be determined may comprise of transaction fees, interest rate, cash advance limits, and/or minimum monthly payment requirements for the cash advance. In another embodiment of the invention, the financial transaction may be cashing of a check at a non-gaming establishment such as a merchant that provides check cashing services, and the term to be determined may comprise a check cashing limit, a guarantee fee, and/or a transaction fee.

Accordingly, the use of player tracking data to determine one or more terms of a financial transaction is not limited to financial transactions that occur within a gaming environment, nor do the financial transactions need to relate to gaming or a gaming establishment.

### Method for Establishing a Check Cashing Limit

The following description of embodiments of the invention are directed to a method for establishing at least one term of a financial transaction wherein the financial transaction is the cashing of a check, and the at least one term evaluated is comprised of a check cashing limit. Although the following descriptions of features and components of the invention are presented in the context of establishing check cashing limits, the following descriptions of the features and components of the invention are also applicable to other embodiments of the invention such as the embodiments depicted in FIGS. 1-2 and discussed hereinabove.

It is very common for casino and similar gaming establishments to provide check cashing services for their patrons. In general, patrons provide a check for a given amount to the casino in exchange for the cash equivalent, and the casino deposits the check into its bank account. Casinos and/or the cash access companies they employ to provide check cashing services establish check cashing limits or the maximum dollar amount of checks they will cash for an individual patron in a given day or window period. The limits are intended to aid the payee manage their risk both on a patron level and across their check casher base. Generally, these limits are calculated based on a variety of inputs such as the player's check cashing history, non-sufficient funds history, and credit score which is generally given the heaviest weighting. While the combination of this information may provide a predictive measure of the patron's propensity to write only checks they can cover, it does not address or take into consideration the total amount in checks they can actually cover. The latter being an important consideration in gaming environments where it is common to have patrons cash several thousands of dollars in checks in a given day or window. Additionally, the credit score is generated by data that is not really relevant to the patron's current propensity and ability to cover elevated check cashing limits, and the credit score has a number of other drawbacks and limitations as discussed in the Background section above. Thus, the credit score may prevent the gaming establishment from issuing elevated check cashing limits, which the patron can sufficiently cover. Furthermore, although the check cashing transaction is discussed in a casino or gaming environment context in the foregoing discussion, the method of the present invention to evaluate check cashing limits is not limited to casino or gaming environments since the consideration of player tracking data is relevant and may be used for check cashing transactions that occur outside of a gaming environment as the check cashing transaction does not need to relate to gaming activity or a gaming establishment.

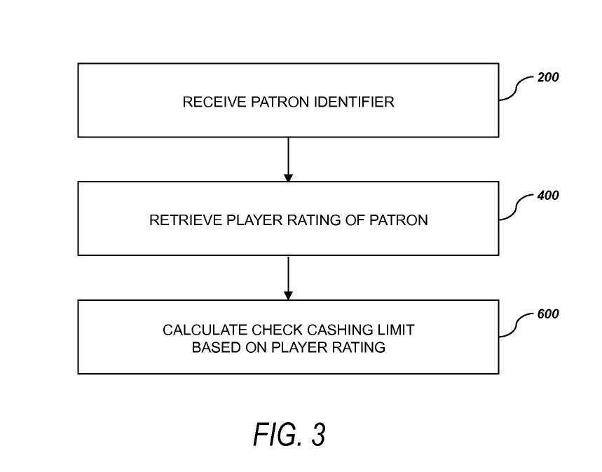

FIG. 3 depicts a block diagram illustrating a method for establishing a check cashing limit in accordance with an embodiment of the present invention. In general, a check cashing system, either alone or in combination with a player tracking system, receives a patron identifier (action 200); retrieves player rating of the patron (action 400); and calculates the check cashing limit based on the player rating (action 600).

A check cashing system of the present invention may perform all or some of actions 200, 400, and 600. For instance, in some embodiments of the invention, a check cashing system of the present invention performs all of actions 200, 400, and 600. Such embodiments may include an electronic interface to the player tracking system and/or may include a database that stores player tracking data. Referring to FIG. 3, the check cashing system receives the patron identifier (action 200), which is inputted into the check cashing system by a person handling the check cashing transaction (“cashier”) or by the patron if using a self-service embodiment of the check cashing system. The check cashing system then retrieves the player rating of the patron (action 400), which is retrieved from a database in the computerized system that stores the player rating and/or retrieved via an electronic connection to the player tracking system. The check cashing system then calculates the check cashing limit based on the player rating 600).

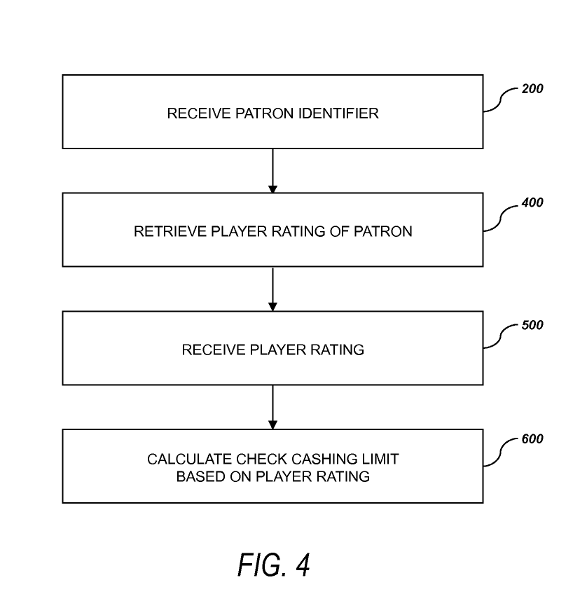

In further embodiments of the invention, a check cashing system of the present invention may work in conjunction with the player tracking system to perform actions 200, 400, and 600, as for example, in embodiments of the invention that do not include an electronic interface to the player tracking system. In such embodiments, the cashier retrieves the player rating from the player tracking system and inputs the player rating into the check cashing system of the present invention. FIG. 4 depicts a block diagram illustrating a method for establishing a check cashing limit in accordance with such embodiments of the present invention. The player tracking system receives a patron identifier (action 200), which is inputted by the cashier. The player tracking system then retrieves the player rating of the patron (action 400). The cashier then inputs the player rating into the check cashing system of the present invention, and consequently, the check cashing system receives the player rating (action 500). The check cashing system then calculates the check cashing limit based on the player rating (action 600).

In an alternate embodiment of the invention, some of actions 200, 400, and 600 may be performed manually by a person. For instance, referring back to FIG. 3, the player tracking system receives a patron identifier (action 200), which is inputted by the cashier. The player tracking system then retrieves the player rating of the patron (action 400). The cashier may then manually calculates the check cashing limit based on the player rating (action 600). For example, the cashier can perform action 600 by using a reference table, chart, or graph that designates various check cashing limit values based on player rating, by using one or more mathematical formulas to calculate the check cashing limit, or by using any other suitable reference.

The patron identifier can be any form of government issued identification such as a driver's license or passport, a player card or reward card issued by the gaming establishment, an identifying number (e.g., social security number, driver's license number, player card number, or house account number), biometric data such as a fingerprint, or any other form of identification that can be used to retrieve the patron's tracking data from either the player tracking system or check cashing system of the present invention.

### Player Tracking Data

The method of the present invention considers player tracking data provided by a player tracking system administered in gaming establishments to determine one or more terms of a financial transaction such as determining a check cashing limit. Player tracking systems have been implemented by casinos and gaming environments as a way for gaming operators to track the gaming activity of their players so that they can determine the value of a player and ‘reward’ their best players for their gaming activity at a variety of games offered by a gaming establishment such as slot machines, video gaming machines (e.g., video poker machines, video keno machines, etc.), table games, and at the race and sports book. The gaming establishment issues cards to the players generally known as player cards, reward cards, players club cards, or loyalty cards to track the gaming activity of a player. The player inserts his or her player card into the gaming machine card reader or provides it to the host at table games so that the player's session activity can be captured and stored in a central database of the player tracking system. As the patron plays, their coin-in (bets) and/or coin-out (payouts) are tracked, and based on the total amount of play in a given period of time, the gaming operator can determine the player's value. This is referred to as rating a player. The player rating may be described in several different manners such as a descriptive value such as Gold, Silver or Bronze (tiers), or the player rating may be described in a numeric form generally referring to their coin-in or coin-out over a period of time. The higher the patron's rating, the more valuable he or she is to the gaming operator.

In addition to the player's coin-in activity (bets) and coin-out activity (payouts), the player tracking data collected by the player tracking system may also include the length of play, length of membership, type of games played, a player's won/loss results, and various types of other player-related data. Furthermore, some player tracking systems may also track other activity such as the player's expenditures or reward redemption towards hotel accommodations, entertainment purchases, restaurants, or retail purchases that occur within a gaming establishment's property or that are affiliated with a gaming establishment. The data collected is not necessarily collected from one gaming establishment. For example, the player tracking system may collect data from affiliated or commonly owned gaming establishments in one or more designated geographic areas or worldwide.

In the embodiments of the invention that uses player tracking data to determine or more terms of a financial transaction as depicted in FIGS. 1-2 and discussed above, the player tracking data retrieved and used in the method of the present invention can be: (i) data preselected by the gaming operator, by the cash access provider, by the person handling the financial transaction, or by the computerized system that evaluates the financial term(s); (ii) data that has been processed by the player tracking system such as the patron's total amount of bets in a given time or the player rating of the patron which can be a descriptive/tier value or a numeric value; or (iii) all data collected by the player tracking system for a particular patron and the computerized system of the present invention may then select the data to be used in its evaluation.

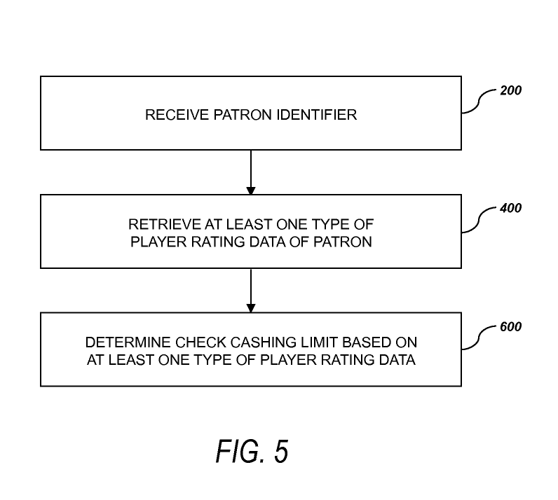

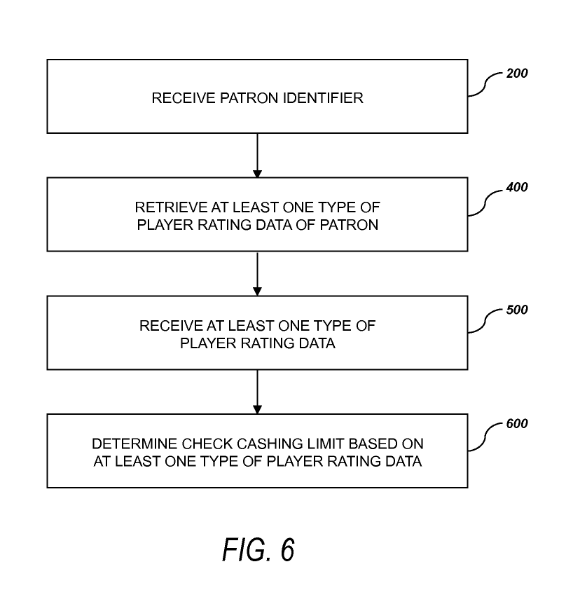

Each gaming establishment may have its own preconfigured formula or method to determine the player rating of its players. The method of the present invention may use the player rating as determined by the gaming establishment's player tracking system to evaluate a check cashing limit as shown in the embodiments of the invention depicted in FIGS. 3-4 and described above. However, in an alternate embodiment of the invention, at least one type of player tracking data (as opposed to the player rating determined by the player tracking system) is used to calculate one or more terms of a financial transaction. For example, in the embodiments of the invention depicted in FIGS. 5-6, at least one type of player rating data is used to calculate a check cashing limit. FIG. 5 depicts a block diagram illustrating a method for establishing a check cashing limit in accordance with such embodiments. In general, a check cashing system, either alone or in combination with a player tracking system, receives a patron identifier (action 200); retrieves at least one type of player rating data of the patron (action 400); and determines the check cashing limit based on the at least one type of player rating data (action 600). The gaming operator or cash access provider can select which type(s) of player rating data will be used to evaluate the check cashing limit. For instance, the type of player rating data may be comprised of the patron's past bets and/or the patron's past winnings.

### Retrieval of Player Tracking Data

In some embodiment of the present invention, the check cashing system maintains an electronic connection to the player tracking system via an interface. For example, in one embodiment of the invention, the electronic connection may be a real-time, electronic connection such as an Internet network connection or a local area network (LAN) to the player tracking system. In such versions of the invention, player rating data is retrieved via the real-time electronic connection to the player tracking system which provides the most current player rating data. Referring to FIG. 5, at the time that a check cashing transaction is conducted, the check cashing system receives the patron identifier (action 200), which is inputted into the check cashing system by the cashier in the form of a government issued identification card, government issued identification number, player card, player card number, house account number or the like. The patron identifier is communicated to the player tracking system so that the player tracking system can retrieve the at least one type of player rating data. The check cashing system then retrieves at least one type of player rating data of the patron (action 400), which is retrieved via a real-time electronic connection to the player tracking system. The at least one type of player rating data is essentially consumed by the check cashing system. In real-time, the check cashing system then determines the check cashing limit based on the at least one type of player rating data (action 600). The check cashing limit determined may be persisted within the check cashing system for later use or may be discarded and recalculated during the next transaction by the patron. Real-time evaluation of the player rating yields the most accurate and risk balanced results with players whose gaming activity is increasing getting increased limits and players whose gaming activity is decreasing getting lower limits.

In a further embodiment of the present invention in which the check cashing system includes an electronic connection to the player tracking system via an interface, player rating data may be bulk loaded into the check cashing system on a periodic basis. Player rating data is exported from the player tracking system and imported into the check cashing system via the electronic connection between the check cashing system and the player tracking system. In such embodiments of the invention, the check cashing system includes a database that stores player rating data for later retrieval. For example, as illustrated in FIG. 5, the check cashing system receives the patron identifier (action 200), which is inputted into the check cashing system by the cashier. The patron identifier is used by the check cashing system to match the player rating data records. The check cashing system then retrieves at least one type of player rating data of the patron (action 400), which is retrieved from a database in the check cashing system. The check cashing system then determines the check cashing limit based on the at least one type of player rating data (action 600).

In an alternate embodiment of the present invention, the check cashing system of the present invention does not include an electronic interface to their player tracking system. In such embodiments, the cashier retrieves the player rating data from the player tracking system and then inputs the player rating data into the check cashing system of the present invention at the time the check cashing transaction is being performed. FIG. 6 depicts a block diagram illustrating a method for establishing a check cashing limit in accordance with such embodiments of the invention. The player tracking system receives a patron identifier (action 200), which is inputted by the cashier. The player tracking system then retrieves at least one type of player rating data of the patron (action 400). The cashier then inputs the at least one type of player rating data into the check cashing system of the present invention, and the check cashing system receives the player rating (action 500). The at least one type of player rating data is essentially digested by the check cashing software and is used to determine the patrons check cashing limit. The check cashing system ultimately determines the check cashing limit based on the at least one type of player rating data (action 600). In other embodiments of the invention, after the player rating data is inputted into the check cashing system, the player rating data may then be stored in a database of the check cashing system for future use. Yet in other variations of the embodiments of the invention depicted in FIGS. 3-6, the patron's check cashing activity data may also be stored in the check cashing system for future use. In such versions of the invention, both the patron's player rating data and check cashing activity may be considered in determining check cashing limits.

### Calculating Check Cashing Limit

The applicants' research shows a strong correlation between player rating and check cashing limits. Players with elevated ratings are generally capable of managing elevated check cashing limits and visa versa. The method of the present invention uses as an input the player rating as determined by the player tracking system or uses as an input at least one type of player rating data to aid in determining the player's check cashing limit. Consideration of the player rating data yields considerably higher check cashing limits with little to no increase in non-sufficient funds activity. The higher limits benefits gaming operators by allowing them to provide increased liquidity to their valued patrons.

Accordingly, in one embodiment of the invention, the check cashing limit may be proportional to the player rating, wherein the higher the player rating, the higher the check cashing limit. For instance, the player rating may be a numerical value determined by the player tracking system, and the check cashing limit is directly proportional to the player rating. The exact values may be calculated based on a direct relationship between the player rating numerical value and the check cashing limit. For instance, the relationship between the check cashing limit and the player rating may be comprised of a direct linear function or a direct linear scale, an exponential function, or other mathematical function. Alternatively, the relationship between the player rating and the check cashing limit is not purely comprised of a mathematical formula. For instance, the gaming operator or cash access provider may assign check cashing values to each possible player rating such that a unique check cashing value corresponds to each player rating. In other embodiments, a range of check cashing limits may be assigned to each possible player rating, or a check cashing limit may be derived from a range of player ratings. For player tracking systems that generate the player rating in text or tier form, a range of check cashing limits (determined by the gaming operator or cash access provider and/or determined by one or more mathematical formulas) may be assigned to each player rating tier.

The gaming operator or cash access provider may also select which type of player rating data to use in calculating the check cashing limit. For example, instead of using the player rating determined by the player tracking system, a gaming operator or cash access provider may choose to only consider player bets and/or player winnings. In such embodiments of the invention, the check cashing limit may be calculated based on a mathematical formula or method in which there is a direct relationship between the player bet and/or player winning data values and the check cashing limit, wherein the higher the player bet and/or player winning data values, the higher the check cashing limit. Alternatively, the gaming operator or cash access provider may choose to only consider total losses of a player. In such embodiments, the check cashing limit may be an inverse relationship of the player's loss value.

In addition to selecting which types of player rating data to use in calculating the check cashing limit, the gaming operator or cash access provider may rank the different types of data such that the higher ranked and more important types of data affect the check cashing limit more than lower ranked types of data. Each type of player rating data may be weighted by the gaming operator or cash access provider in accordance with its relative importance and impact on the check cashing limit. The gaming operator or cash access provider may use its own predetermined specific algorithms, formulas and/or other methods to calculate the check cashing limit and may incorporate its own ranking of data via the inclusion of coefficients and/or constant values in formulas or algorithms. For example, values may be assigned to different types of player rating data in which the values represent a quantitative representation of the relative importance of each type of player rating data in relation to the check cashing limit. The values may be assigned using any suitable practice known in the art. For instance, player rating data may include a coefficient in which the player rating data type is multiplied by any number or fraction designating the relative importance of the player rating data type. Also a constant value may be added or subtracted from a player rating data value to designate the relative importance of the player rating data type in calculating the check cashing limit. The assigned values to the different types of player rating data may then be combined to generate a check cashing limit by summation of the assigned values, by summation of the assigned values and by multiplying or dividing the sum with a conversion factor, or by any other suitable method. Any of the foregoing practices may be used to create a formula that is unique to the gaming operator or cash access provider. Alternatively, any of the foregoing techniques can be employed in various embodiments of the present invention for general use, and the gaming operator or cash access provider may then adjust the formula in accordance with its preferences. For instance, the gaming operator or cash access provider may adjust the relative importance and impact of a certain type of player rating data on calculating the check cashing limit by adjusting the value of the coefficient and/or constant assigned to that certain type of player rating data.

The check cashing limit calculated may be stored within the check cashing system for later use. The check cashing limit may be valid for a designated period of time (e.g., 24 hour period), in which case the patron may write multiple checks (with an aggregate total not to exceed the check cashing limit) during the designated period of time. Alternatively, the check cashing limit may be valid for one-time use and is recalculated during the next check cashing transaction by the patron.

Any of the foregoing practices to calculate the check cashing limit may be included in a check cashing limit algorithm to be implemented into software and/or a computerized system to execute the method for establishing a check cashing limit of the present invention.

### Check Cashing System

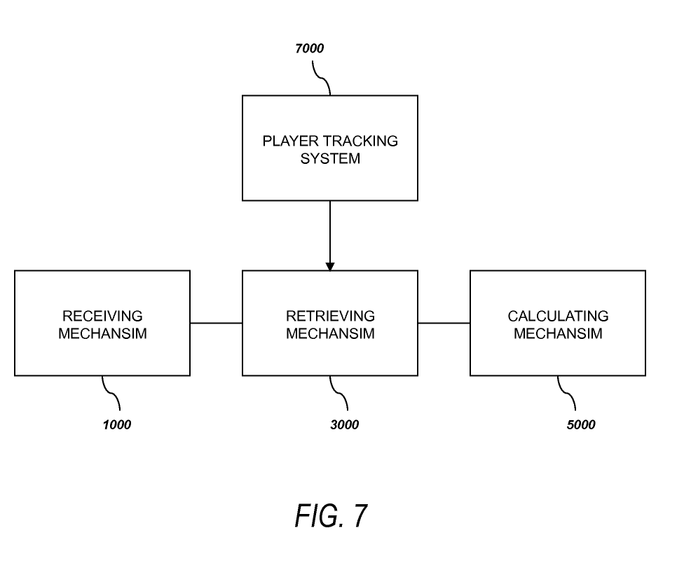

Another aspect of the present invention is directed to a check cashing system. FIG. 7 depicts a block diagram illustrating a check cashing system in accordance with an embodiment of the present invention. The check cashing system comprises: a receiving mechanism 1000 that receives a patron identifier; a retrieving mechanism 3000 that retrieves player rating data wherein the player rating data is provided by a player tracking system 7000; and a calculating mechanism 5000 that calculates a check cashing limit based on the player rating data.

Retrieving mechanism 3000 may be comprised of a real-time electronic connection between the check cashing system of the present invention and player tracking system 7000. Player rating data is retrieved from player tracking 7000 via the real-time electronic connection such as an Internet connection or a LAN (local area network). In a further embodiment, the check cashing system may further include a database that stores the player rating data, and retrieving mechanism 3000 updates the database by periodically transferring the player rating data from player tracking system 7000 to the database.

In an alternate embodiment of the invention, receiving mechanism 1000 and retrieving mechanism 3000 may be contained in player tracking system 7000. In such versions of the invention, there is no electronic connection or interface between the check cashing system and player tracking system 7000 as the player rating data is separately retrieved from player tracking system 7000 and then inputted into the check cashing system of the present invention. In such embodiments, the check cashing system further includes a second receiving mechanism that receives the player rating data after it is retrieved from player tracking system 7000 and inputted into the check cashing system.

In various embodiments of the check cashing system of the present invention, receiving mechanism 1000, retrieving mechanism 3000, and calculating mechanism 5000 may each be comprised of software and/or hardware components. For example, in one embodiment of the invention, receiving mechanism 1000 may be comprised of computer code for receiving the patron identifier, retrieving mechanism 3000 may be comprised of computer code for retrieving player rating data, and calculating mechanism 5000 may be comprised of computer code for calculating the check cashing limit based on the player rating data; and receiving mechanism 1000, retrieving mechanism 3000, and calculating mechanism 5000 may be implemented into a software program. In another embodiment of the invention, receiving mechanism 1000 may be comprised of at least one hardware component to receive the patron identifier (e.g., keyboard, player card reader, identification card reader, magnetic stripe reader, barcode reader, etc.) and computer code for receiving the patron identifier; retrieving mechanism 3000 may be comprised of computer code for retrieving player rating data; and calculating mechanism 5000 may be comprised of computer code for calculating the check cashing limit based on the player rating data. Thus, receiving mechanism 1000, retrieving mechanism 3000, and calculating mechanism 5000 are capable of various embodiments.

### EXAMPLES

In the foregoing description of embodiments of the invention, reference was made to the accompanying figures, which form a part of this application. The figures show, by way of illustration, certain embodiments in which the invention may be practiced. It is to be understood that other variations are possible and modifications may be made without departing from the scope of the present invention. A variety of embodiments are possible wherein each embodiment includes a variation or different combination of the different aspects and elements of the present invention.

For example, in one embodiment, a method for establishing at least one term of a financial transaction is comprised of: (a) receiving a player identifier; (b) retrieving player tracking data wherein the player tracking data is provided by a player tracking system; and (c) determining the at least one term based on the player tracking data. The financial transaction may be a loan, and the at least one term may be comprised of a transaction fee; or the at least one term may be comprised of an interest rate and a principal amount of the loan. In another version, the financial transaction may be a withdrawal of money from an automated teller machine, and the at least one term is comprised of a transaction fee and/or bill denominations to be dispensed. Also, the financial transaction may be a cash advance from a credit card, and the at least one term is comprised of a transaction fee. Nonetheless, the financial transaction may be the cashing of a check, and the at least one term is comprised of a check cashing limit, guarantee fee, and/or transaction fee.

In another example, an alternate embodiment of the invention is directed to a method for establishing a check cashing limit for a patron of a gaming establishment comprised of: (a) receiving a patron identifier; (b) retrieving a player rating of the patron wherein the player rating is determined by a player tracking system; and (c) calculating the check cashing limit based on the player rating. The check cashing limit may be proportional to the player rating. For instance, the player rating may be a numerical value and the check cashing limit is directly proportional to the player rating. The player rating may be retrieved through a real-time electronic connection to the player tracking system such as one comprised of an Internet connection or a local area network (LAN). Alternatively, the player rating may be periodically exported from the player tracking system and imported into a check cashing system. For versions of the invention which do not include an electronic interface to the player rating (i.e., the player rating is obtained from the player tracking system and then inputted into the check cashing system), the method may further comprise receiving the player rating by a check cashing system after retrieving the player rating of the patron from the player tracking system. In another version of the invention, the method may further comprise storing check cashing activity data of the patron into a check cashing system, and such data may be used along with the patron's player rating data to evaluate future check cashing limits. In a variation of the foregoing example, at least one type of player rating data of the patron is retrieved (instead of the player rating as determined by the player tracking system). The at least one type of player rating data to be considered for the check cashing limit calculation can be any type of player rating data selected by a gaming operator or cash access provider. For instance, the at least one type of player rating data may be comprised of the patron's past bets and/or the patron's past winnings.

In a further example, a check cashing system is comprised of: (a) a receiving mechanism that receives a player identifier; (b) a retrieving mechanism that retrieves player rating data wherein the player rating data is provided by a player tracking system; and (c) a calculating mechanism that calculates a check cashing limit based on the player rating data. The retrieving mechanism may be comprised of a real-time electronic connection between the check cashing system and the player tracking system. The check cashing system may further include a database that stores the player rating data wherein the retrieving mechanism updates the database by periodically transferring the player rating data from the player tracking system to the database. Furthermore, the receiving mechanism and the retrieving mechanism may be contained in the player tracking system (for versions of the invention which do not include an electronic interface to the player tracking system), and the check cashing system further includes a second receiving mechanism that receives the player rating data after it is retrieved from the player tracking system and inputted into the check cashing limit.

Although the present invention has been described above in considerable detail with reference to certain versions thereof, other versions are possible. Some of the actions for determining one or more terms of a financial transaction and for establishing a check cashing limit in the methods discussed hereinabove may be modified, added, omitted, or performed in various sequences without departing from the scope of the invention. Additionally, the check cashing system of the present invention may in include components not described hereinabove, and the receiving mechanism, retrieving mechanism, and calculating mechanism may each be comprised of software and/or hardware components and implemented in various ways.

While the description above refers to particular embodiments of the present invention, it will be understood that many modifications may be made without departing from the spirit thereof. The presently disclosed embodiments are therefore to be considered in all respects as illustrative and not restrictive.

What is claimed is:

1. A method for establishing at least one term of a financial transaction, the method comprising:
receiving a player identifier;
retrieving player tracking data wherein the player tracking data is provided by a player tracking system; and
determining the at least one term based on the player tracking data.

2. The method of claim 1 wherein the financial transaction is a loan and the at least one term is comprised of a transaction fee.

3. The method of claim 1 wherein the financial transaction is a loan and the at least one term is a comprised of an interest rate and a principal amount of the loan.

4. The method of claim 1 wherein the financial transaction is a withdrawal of money from an automated teller machine and the at least one term is comprised of a transaction fee.

5. The method of claim 1 wherein the financial transaction is a withdrawal of money from an automated teller machine and the at least one term is comprised of bill denominations to be dispensed.

6. The method of claim 1 wherein the financial transaction is a cash advance from a credit card and the at least one term is comprised of a transaction fee.

7. The method of claim 1 wherein the financial transaction is cashing of a check and the at least one term is comprised of a check cashing limit.

8. The method of claim 1 wherein the financial transaction is cashing of a check and the at least one term is comprised of a check cashing limit and a transaction fee.

9. The method of claim 1 wherein the financial transaction is cashing of a check and the at least one term is comprised of a guarantee fee.

10. A method for establishing a check cashing limit for a patron of a gaming establishment, the method comprising:
receiving a patron identifier;
retrieving a player rating of the patron wherein the player rating is determined by a player tracking system; and
calculating the check cashing limit based on the player rating.

11. The method of claim 10 wherein the check cashing limit is proportional to the player rating.

12. The method of claim 10 wherein the player rating is a numerical value and the check cashing limit is proportional to the player rating.

13. The method of claim 10 wherein the player rating is retrieved through a real-time electronic connection to the player tracking system.

14. The method of claim 13 wherein the real-time electronic connection is comprised of an Internet connection.

15. The method of claim 10 further comprising receiving the player rating by a check cashing system after retrieving the player rating of the patron

16. The method of claim 10 wherein the player rating is periodically exported from the player tracking system and imported into a check cashing system.

17. The method of claim 10 further comprising storing check cashing activity data of the patron into a check cashing system.

18. A method for establishing a check cashing limit for a patron of a gaming establishment, the method comprising:
receiving a patron identifier;
retrieving at least one type of player rating data of the patron wherein the at least one type of player rating data is provided by a player tracking system; and
determining the check cashing limit based on the at least one type of player rating data.

19. The method of claim 18 wherein the at least one type of player rating data is comprised of the patron's past bets.

20. The method of claim 18 wherein the at least one type of player rating data is comprised of the patron's past bets and the patron's past winnings.

21. The method of claim 18 wherein the at least one type of player rating data is retrieved through a real-time electronic connection to the player tracking system.

22. The method of claim 18 further comprising receiving the at least one type of player rating data by a check cashing system after retrieving the at least one type of player rating data.

23. The method of claim 18 wherein the at least one type of player rating data is periodically transferred from the player tracking system to a check cashing system.

24. A check cashing system comprising:
a receiving mechanism that receives a player identifier;
a retrieving mechanism that retrieves player rating data wherein the player rating data is provided by a player tracking system; and
a calculating mechanism that calculates a check cashing limit based on the player rating data.

25. The check cashing system of claim 24 wherein the retrieving mechanism is comprised of a real-time electronic connection between the check cashing system and the player tracking system.

26. The check cashing system of claim 24 further comprising a database that stores the player rating data wherein the retrieving mechanism updates the database by periodically transferring the player rating data from the player tracking system to the database.

27. The check cashing system of claim 24 wherein the receiving mechanism and the retrieving mechanism are contained in the player tracking system and the check cashing system further comprises a second receiving mechanism that receives the player rating data.
